(19) United States
(12) Patent Application Publication
(10) Pub. No.: US 2017/0083709 A1
(43) Pub. Date: Mar. 23, 2017

(54) REPLICATION OF DATA ENCRYPTED USING SYMMETRIC KEYS

(71) Applicants: Sean Bartholomew SIMMONS, Waterloo (CA); Nagula Tharma SANGARY, Waterloo (CA); Mahinthan VELUPPILLAI, Waterloo (CA)

(72) Inventors: Sean Bartholomew SIMMONS, Waterloo (CA); Nagula Tharma SANGARY, Waterloo (CA); Mahinthan VELUPPILLAI, Waterloo (CA)

(21) Appl. No.: 14/862,845

(22) Filed: Sep. 23, 2015

(51) Int. Cl. G06F 21/60; G06F 17/30

(52) U.S. Cl. CPC G06F 21/602; G06F 17/30575

(57) ABSTRACT

In one aspect there is provided a backup server that may store data in one or more databases—each database being associated with a user and having a user ID associated with the database. Each database may have one or more partitions—each partition being associated with an entity. Each data element is stored in the database associated with the user from which the data element is received, and is stored in a partition associated with entities that are authorized to access the data element. Furthermore, the backup server may determine which entities are authorized to access the data, using a policy database, and store the data element in a partition associated with each authorized entity. Third-party entities may request data from the backup server by sending a data request.

### TECHNICAL FIELD

Example embodiments relate generally to techniques for data encryption, storage, and replication of encrypted data, and more particularly to replicating data encrypted using symmetric keys.

### BACKGROUND

Users of computing systems generate a large volume of data, some of which may be private and sensitive in nature. One example of private data may be sensor data generated by sensor devices that measure personal parameters, such as health monitoring devices. The growth of sensor devices and of computing devices incorporating sensors has resulted in a great amount of sensor data being collected.

Users may wish to keep private data confidential and away from prying eyes and at the same time users may also wish to back up their data at an off-site computing device. Such backups are typically referred to as backing up data to the cloud. However, sending plaintext data to a cloud computing service provide exposes the data to hackers to the cloud computing service provider. Users have at times encrypted their data, then sent the encrypted data to the cloud computing service provider. However, this prevents the cloud computing service provider from utilizing the data to provide additional services. In one example, a user wishes to back up their encrypted health data to a cloud service provider, and have the cloud service provider forward the data to the a health professional. However, the cloud service provider will be unable to recognize that the data is health data that should be forwarded to the health professional. Furthermore, the health professional will be unable to decrypt the data without the proper key from the user. Accordingly, it may be advantageous to provide a system for backing up encrypted data and selectively sharing data.

### SUMMARY OF EXAMPLE EMBODIMENTS

In one aspect there is provided a method implemented by a computing device storing data in one or more databases, each database being associated with a user and having a user ID associated therewith, and each database having one or more partitions, each partition being associated with one or more entities. The method comprises, receiving, from a requesting entity, a request to send data associated with the requesting entity, the request including a requestor public key associated with the requesting entity; retrieving, from memory, a policy database, the policy database defining entities that are authorized to access each of the one or more partitions, each entity being uniquely identifiable by an entity public key associated with the entity; identifying, based on the requestor public key and the policy database, partitions that the requesting entity is authorized to access; determining which of the one or more databases store one or more partitions that the requesting entity is authorized to access; and for each database that stores one or more partitions that the requesting entity is authorized to access, sending, to the requesting entity, the data stored in the one or more partitions that the requesting entity is authorized to access and a user ID associated with the database.

In another aspect there is provided a computing-device storing data in one or more databases, each database being associated with a user and having a user ID associated therewith, and each database having one or more partitions, each partition being associated with one or more entities. The computing-device includes a processor; and memory coupled to the processor and storing instructions for encrypting a data element. The processor may be configured to: receive, from a requesting entity, a request to send data associated with the requesting entity, the request including a requestor public key associated with the requesting entity; retrieve, from memory, a policy database, the policy database defining entities that are authorized to access each of the one or more partitions, each entity being uniquely identifiable by an entity public key associated with the entity; identify, based on the requestor public key and the policy database, partitions that the requesting entity is authorized to access; determine which of the one or more databases store one or more partitions that the requesting entity is authorized to access; and for each database that stores one or more partitions that the requesting entity is authorized to access, send, to the requesting entity, the data stored in the one or more partitions that the requesting entity is authorized to access and a user ID associated with the database.

In yet another aspect, there is provided a non-transient computer readable medium containing program instructions for causing a computing device storing data in one or more databases, each database being associated with a user and having a user ID associated therewith, and each database having one or more partitions, each partition being associated with one or more entities to perform the method of: receiving, from a requesting entity, a request to send data associated with the requesting entity, the request including a requestor public key associated with the requesting entity; retrieving, from memory, a policy database, the policy database defining entities that are authorized to access each of the one or more partitions, each entity being uniquely identifiable by an entity public key associated with the entity; identifying, based on the requestor public key and the policy database, partitions that the requesting entity is authorized to access; determining which of the one or more databases store one or more partitions that the requesting entity is authorized to access; and for each database that stores one or more partitions that the requesting entity is authorized to access, sending, to the requesting entity, the data stored in the one or more partitions that the requesting entity is authorized to access and a user ID associated with the database.

### BRIEF DESCRIPTION OF THE DRAWINGS

Reference will now be made, by way of example, to the accompanying drawings which show example embodiments, and in which:

FIG. 1 illustrates in block-diagram form an example environment within which example embodiments can be practiced;

FIG. 2 illustrates in block-diagram form a storage device suitable for encrypting data in accordance with example embodiments;

FIG. 3 illustrates in block-diagram form a backup server for storing encrypted data generated by the storage device of FIG. 2;

FIG. 4 illustrates in block-diagram form a third-party device capable of receiving encrypted data from the backup server of FIG. 3;

FIGS. 5A, 5B, 5C and 5D illustrate in block-diagram form example files storing encrypted data elements in accordance with example embodiments; and

FIGS. 6A and 6B illustrate example flowcharts of methods for storing and replicating encrypted data elements by the backup server of FIG. 3.

Similar reference numerals may have been used in different figures to denote similar components.

### DETAILED DESCRIPTION OF EXAMPLE EMBODIMENTS

A storage device is configured to receive data elements for encryption and storage. For each data element received at the storage device, the storage device may generate a symmetric key and encrypt the data element using the symmetric key. In one embodiment, the symmetric key is associated with a data element and is only used to encrypt one data element.

The storage device may receive data from sensor devices that collect and send sensor data to the storage device. The storage device may determine which entities are authorized to view each data element received at the storage device. Entities may include corporations (e.g. health-insurance companies), professionals (e.g. doctors), and individuals (e.g. relatives of the user). The storage device may store a policy database defining entities that are authorized to access each data element the storage device receives. Access may be defined based on the device that sent the data element to the storage device. For example, only entities associated with health-professionals may be authorized to access data collected by a blood pressure monitoring sensor device, and on the other hand, only entities associated with home-monitoring professionals may be authorized to access data collected by a security perimeter sensor device.

The storage device may send the encrypted data element to a backup server, and the backup server may send the encrypted data element to the authorized entities. However, the authorized entities do not know the symmetric key used to encrypt the data element. Accordingly, the storage device must also send the symmetric key to the authorized entity (via the backup server). However, sending the symmetric key in plaintext would jeopardize the security of the encrypted data element and allow attackers to decrypt the encrypted data elements. Accordingly, the storage device may encrypt the symmetric key using a key that the authorized entity can decrypt; such as a public key associated with the authorized entity. The public key associated with the authorized entity is part of a key pair. The key pair includes a private key, which is kept secret and is only known to the authorized entity, and the public key. The private key is needed to decrypt data encrypted using the public key of the key pair.

The storage device may thus store public keys associated with various entities. The storage device may encrypt the symmetric key using the public key of each authorized entity. If multiple entities are authorized to access the data element, the storage device may encrypt the symmetric key multiple times—once for each authorized entity, using the public key associated with each authorized entity. The storage device may append the encrypted symmetric key or keys to the file storing the encrypted data element. The storage device may thus provide selective access to sensor data based on the policy database.

The encrypted data stored at the storage device may be sent to the backup server and other entities that are not authorized to access data without jeopardizing the security of the data. Unauthorized entities do not have the private key needed to decrypt the encrypted symmetric keys. The storage device may therefore send the encrypted data to a backup server for storage without jeopardizing the security of the data. If the backup server is not an authorized entity, then the backup server will be unable to decrypt the encrypted data.

The backup server may act as a hub for user data, such as sensor data. The backup server may store data in one or more databases—each database being associated with a user and having a user ID associated with the database. Each database may have one or more partitions—each partition being associated with an entity. Each data element is stored in the database associated with the user from which the data element is received, and is stored in a partition associated with entities that are authorized to access the data element. For example, if a data element is sent from a storage device associated with User ‘X’, the data element is stored at the backup server in a database associated with User ‘X’. Furthermore, the backup server may determine which entities are authorized to access the data, using a policy database, and store the data element in a partition associated with each authorized entity.

Third-party entities may therefore request data from the backup server by sending a data request. Upon receiving a data request from a third party entity, backup server may identify, based on a public key associated with the requesting entity, partitions that the requesting entity is authorized to access. Backup server may determine which user databases store partitions that the requesting entity is authorized to access, and send data stored in the partitions that the requesting entity is authorized to access to the requesting entity.

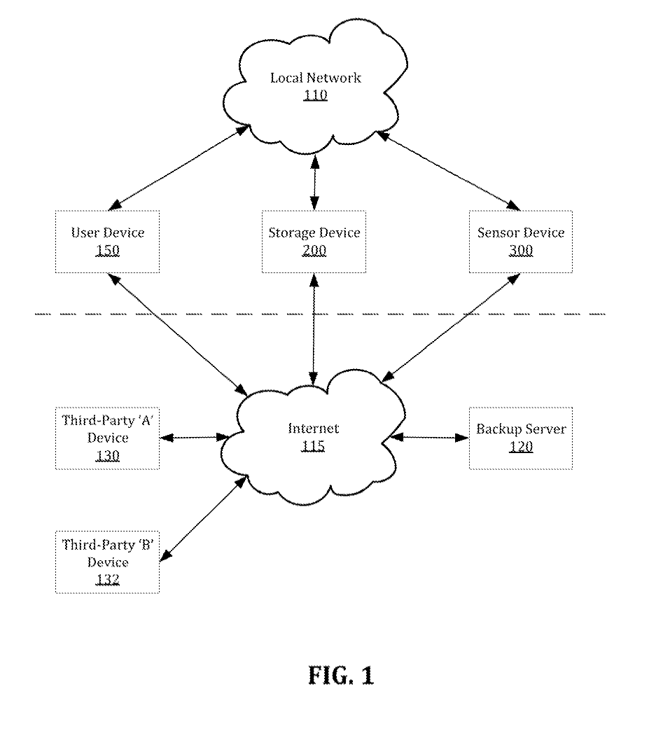

FIG. 1 illustrates an example environment within which the techniques of the example embodiments may be practiced. As shown in FIG. 1, storage device 200 and sensor device 300 are communicatively coupled to one another via location network 110 or via Internet 115. Sensor device 300 includes at least one sensor, such as an accelerometer, a barometer, a flow sensor, a carbon monoxide sensor, a smoke sensor, a heat sensor, a thermometer, a blood glucose sensor, a cholesterol sensor, a magnetometer, an oxygen sensor, and a pH sensor. Sensor device 300 may collect sensor data, which may be associated with one or more users, and may send the sensor data to storage device 200 at periodic intervals. Storage device 200 may receive, via local network 110 or via Internet 115, the sensor data from sensor device 300.

Optionally, storage device 200 may also be coupled to a user device 150, via local network 110 or Internet 115. User device 150 may be any one of a mobile phone, smartphone or superphone, tablet computer, notebook computer (also known as a laptop, netbook or ultrabook computer depending on the device capabilities), wireless organizer, personal digital assistant (PDA). As will become apparent, user device 150 may perform substantially the same functions as storage device 200; for example, user device 150 may be coupled to sensor device 150 and may receive data from sensor device 300 via local network 110 or via Internet 115. User device 150 may also encrypt and store data in accordance with the embodiments described.

Local network 110 may act as an intranet, connecting local computing device to one another. Local network 110 may be configured as a wired or wireless personal area network (PAN) in accordance with any known communication protocols, including, without limitations, INSTEON, Wi-Fi™, Wi-Fi Direct™, Infrared Data Association (IrDA), wired or wireless USB™, Bluetooth™, Z-Wave™, and ZigBee™. Local network 110 may alternatively include a routing device and be configured as a local area network (LAN) or a wireless local area network (WLAN), or may include elements of both a PAN and a LAN.

Storage device 200 (and user device 150) may also be coupled to a backup server 120, via Internet 115. Storage device 200 may optionally send encrypted sensor data collected by sensor device 300 to backup server 120 for routine and regular backup of the sensor data. Storage device 200 may also send to backup server 120 user identification information associated with the sensor data. Backup server 120 may store the received sensor data in a database.

Storage device 200 and backup server 120 (and user device 150) may also be coupled to third-party devices, via Internet 115. Shown in FIG. 1 are third-party ‘A’ device 130 and third-party ‘B’ device 132. Each third-party device may be associated with an entity. Storage device 200 may send data directly, via the Internet, to one of the third-party devices. Alternatively, storage device 200 may send data to backup server 120 for storage. One or more third-party devices may then send a request to backup server 120 to receive data associated with one or more users. Backup server 120 may send, via Internet 115, data elements to third-party devices that are authorized to access the data elements.

In one embodiment, third party ‘A’ device 130 is owned and operated by a healthcare provider (such as any one of a doctor, a hospital, and a health insurance company) and sensor device 300 is configured to collect and store health data associated with a user. When the user visits the healthcare provider, the healthcare provider will benefit from accessing the sensor data to provide better services to the user. The user may therefore authorize the healthcare provider to access the data associated with sensor device 300. Third party ‘A’ device 130 may send a request to access health related sensor data to either backup server 120 or storage device 200.

While user device 150, storage device 200, and sensor device 300 are shown as three separate devices in FIG. 1, in some embodiments, the functionality associated with each of the three devices may be implemented in a single device. Furthermore, in some embodiments, storage device 200 may not be connected to user device 150 and sensor device 300 via a local network, and instead, the devices may communicate with one another via Internet 115.

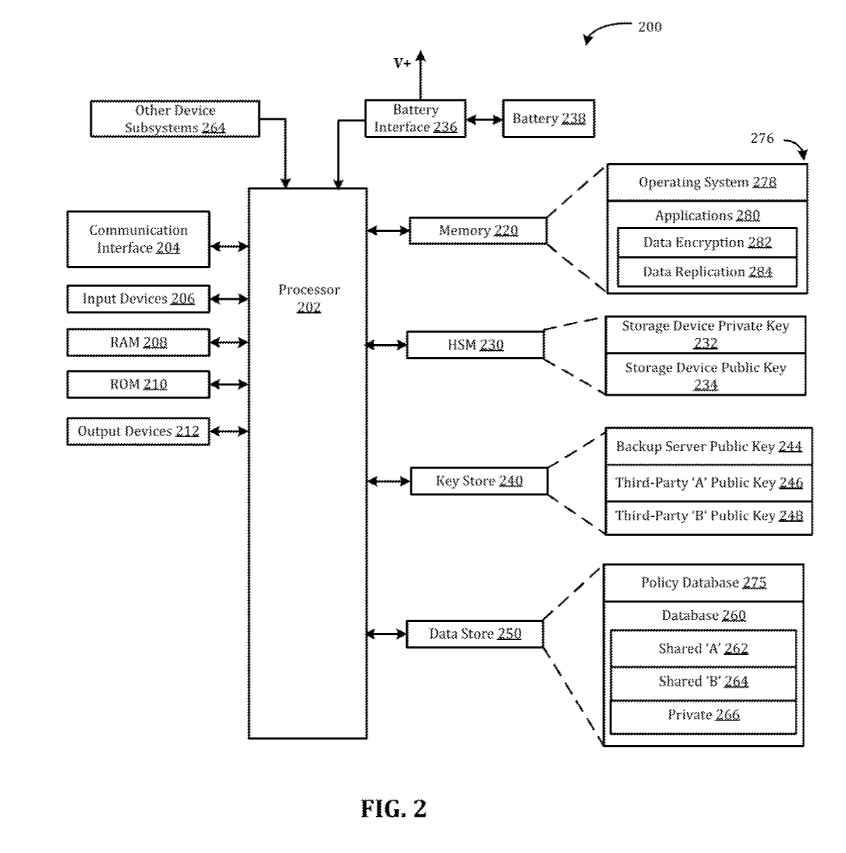

Having illustrated example environments within which the techniques of the example embodiments may be practiced, now more details regarding the storage device 200 will be described, as shown in FIG. 2. FIG. 2, illustrates, in block diagram form, an example storage device 200 suitable for encrypting data in accordance with example embodiments. Examples of storage device 200 include, but are not limited to, a notebook computer (also known as a laptop, netbook or ultrabook computer depending on the device capabilities), a desktop computer, a purpose-built server computer, and a generic server computer.

Storage device 200 may include a rigid case (not shown) housing the electronic components of storage device 200. The electronic components of storage device 200 may be mounted on a printed circuit board (not shown) and/or communicatively coupled thereto by a communications cable. Storage device 200 includes a processor 202, which controls the overall operation of storage device 200. Communication functions are performed through a communication interface 204. Communication interface 204 receives data and messages and sends data and messages via either Internet 115 or local network 110. Communication interface 204 typically includes an Ethernet interface for communication over wired networks, and a WLAN interface for communication over Wi-Fi™ and/or Bluetooth™ networks.

Processor 202 interacts with other components including one or more input devices 206 (such as a pushbutton, a keyboard, and/or touch-sensitive display), one or more output devices 212 (such as an LED, and/or a display), RAM 208, ROM 210, persistent (non-volatile) memory 220, auxiliary I/O subsystems (not shown), one or more data port (not shown) such as serial data port (e.g., USB data port), data store 250, HSM 203, key store 240, and other device subsystems generally designated as 264. The components of storage device 200 are coupled via a communications bus (not shown) which provides a communication path between the various components.

Processor 202 operates under stored program control and executes software modules 276 stored in memory 220. As illustrated in FIG. 2, the software modules 276 comprise operating system software 278 and software applications 280. The software applications 280 may include a data encryption application 282 and a data replication application 284. The software modules 276 or parts thereof may be temporarily loaded into volatile memory such as the RAM 208. The RAM 208 is used for storing runtime data variables and other types of data or information. Although specific functions are described for various types of memory, this is merely one example, and a different assignment of functions to types of memory could be used.

Input devices 206 may include a keyboard, control buttons (not shown) such as a power toggle (on/off) button, volume buttons, general purpose or context specific buttons, ‘back’ or ‘home’ buttons, and/or a navigation device. When a display screen is provided as part of a touchscreen, the various buttons or controls may be provided by onscreen user interface elements displayed on the display screen instead of, or in addition to, physical interface components. The keyboard may be provided instead of, or in addition to, a touchscreen depending on the embodiment. At least some of the control buttons may be multi-purpose buttons rather than special purpose or dedicated buttons.

Output devices 212 may include an LED indicator, a touch-sensitive display, a dot-matrix display or other type of display. Output devices 212 are operably coupled to an electronic controller (not shown) and to processor 202. User-interaction with a GUI (graphical user interface) is performed through input devices 206. Information, such as LED light patterns, text, characters, symbols, images, icons, and other items are rendered and displayed on output devices 212 via processor 202.

Storage device 200 may optionally include a battery 238 to provide a power source. Typically, one or more rechargeable batteries are used, which may be charged, for example, through charging circuitry coupled to a battery interface such as a serial data port (not shown). Battery 238 provides electrical power to at least some of the electrical circuitry in sensor device 200, and battery interface 236 provides a mechanical and electrical connection for battery 238. Battery interface 236 is coupled to a regulator (not shown) which provides power V+ to the circuitry of sensor device 200.

Communication interface 204 may include a short-range wireless communication subsystem (not shown) which provides a short-range wireless communication interface. The wireless communication interface may be configured in accordance with one or more cellular telecommunication standards, including any of a Bluetooth™ standard, an IEEE 802.11 standard (also referred to as Wi-Fi™), an IEEE 802.15.3a standard (also referred to as UWB), a Z-Wave standard, a ZigBee™ standard or other suitable short-range wireless communication standard. A received signal, such as a message or sensor data, is processed by communication subsystem 204 and input to processor 202. Processor 202 encrypts the received signal in accordance with the data encryption application 282 or any other application in the memory 220.

Processor 202 is also communicatively coupled with data store 250, which is a computer readable medium for long-term data storage, such as a hard-disk drive, a solid-state drive, an optical storage device, and a magnetic tape. Data store 250 stores data, including user data in database 260 and a policy database 275 defining rules for storage, encryption, and access of data stored in database 260. Policy database 275 may specify which entity or entities are authorized to access data received from each sensor device. For example, data from a sensor device collecting blood-pressure measurements may be associated in the policy database 275 with a health-monitoring entity. Policy database 275 may also store rules specifying the frequency at which data from each sensor device should be sent to backup server 120 (e.g. never, every hour, every day, every week, ect).

Database 260, on the other hand, stores data received from sensor devices and other user data. As shown, database 260 includes three partitions, Shared ‘A’ 262, Shared ‘B’ 264, and Private 266. Policy database 275 may include rules specifying which partition data from each sensor device should be stored. For example, policy database 275 may require that all health related data be stored in partition Shared ‘A’ 262, all home monitoring related data be stored in partition Shared ‘B’ 264, and all financial information be stored in partition Private 266. Policy database 275 may further specify which entities are authorized to access data stored in each partition. For example, a health monitoring entity may be authorized to access data stored in partition Shared ‘A’ 262, a home monitoring entity may be authorized to access data stored in partition Shared ‘B’ 264, and no third-party may be authorized access to data stored in partition Private 266 (i.e. only sensor device 200 may access the data in stored in the partition, such as financial data).

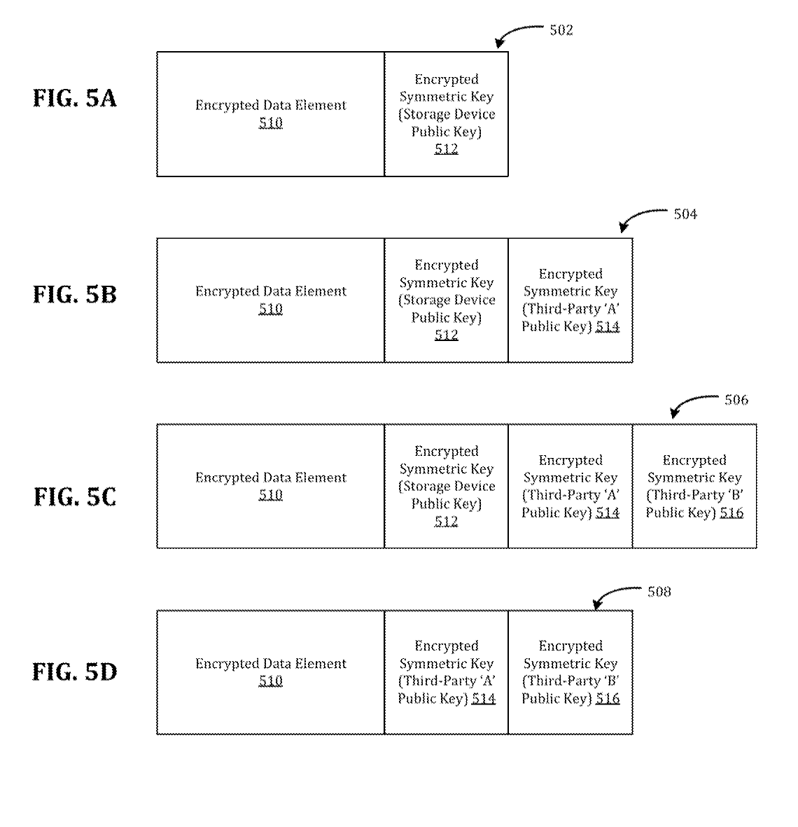

Database 260 may be implemented using a NoSQL database (such as CouchDB™, or MongoDB™) using unstructured data. When storage device 200 receives a data element storing sensor data from a sensor device, storage device 200 may encrypt the data element in accordance with example embodiments. Storage device 200 may then store the encrypted data element in database 260 in accordance with the rules set out in policy database 275. A file storing encrypted data is thus created and stored in database 260. Example files are shown in FIGS. 5A-5D.

Processor 202 may also be communicatively coupled with Hardware Security Module (‘HSM’) 230. HSM 230 provides secure, tamper proof storage for encryption keys, and stores storage device private key 232 and storage device public key 234. Private and public keys 232, 234 are a mathematically linked key-pair associated exclusively with storage device 200. Private and public keys 232, 234 may be created by storage device 200 during initial set-up, or alternatively, storage device 200 may receive private and public keys 232, 234 during manufacturing of storage device 200. Public key 234 associated with storage device 200 may be distributed freely amongst users of the system, however, private key 232 is kept secret from all other devices. Public key 232 may be used to identify storage device 200 to other devices in the system, such as backup server 120 or third-party ‘A’ device 130 or third-party ‘B’ device 132, by sending public key 232 to the other device.

In some embodiments, storage device 200 may send public key 234 to a certificate authority (CA), which may be implemented using backup server 120. Upon receiving the public key from storage device 200, the CA may encrypt public key 234 using the private key associated with backup server 120. Public key 234 is now said to be ‘signed’. Backup server 120 sends the signed public key back to storage device 200, which storage device 200 may store in HSM 230 (not shown). Public key 234 is now said to be ‘registered’ with backup server 120, and may be used to securely identify public key 234 as being associated with storage device 200.

Processor 202 may also be communicatively coupled with key store 240, which stores public keys associated with various entities that storage device 200 is registered with, such as backup sever public key 244, third-party ‘A’ pubic key 246, and third-party ‘B’ public key 248.

Backup server 120 public key 244 may be distributed to every device which utilizes the system. Accordingly, any device is able to decrypt a signed public key. If a device receives a signed public key, the device can verify that the public key has been registered with backup server 120 by decrypting the signed public key using the public key associated with backup server 120. Since backup server 120 is a trusted entity, an entity that has a public key signed by backup server 120 may be trusted by other entities. Each device may therefore send the signed public key associated with it to identify itself to other devices and may rely on signed public keys as proof of identity.

Storage device 200 may register with a third-party entity by sending a request to a device associated with the third-party entity (e.g. third-party ‘A’ device 130 or third-party ‘B’ device 132), via Internet 115, to receive the unsigned or signed public key associated with the device. Upon receiving a signed public key, storage device 200 may decrypt the signed public key using the public key associated with backup server 120, then store the public key associated with the device in key store 230. As shown in FIG. 2, key store 230 stores the public keys associated with Third-Party ‘A’ and Third-Party ‘B’. By registering with the third-party entity, and by receiving and storing the third-party entity public keys, storage device 200 is able to provide the third-party entity access to at least a subset of data stored on storage device 200 by using the third-party entity public key to encrypt the symmetric keys which it encrypts data elements with. Furthermore, when storage device 200 registers with a third-party entity, policy database 275 may be updated to indicate data the third-party entity is authorized to access.

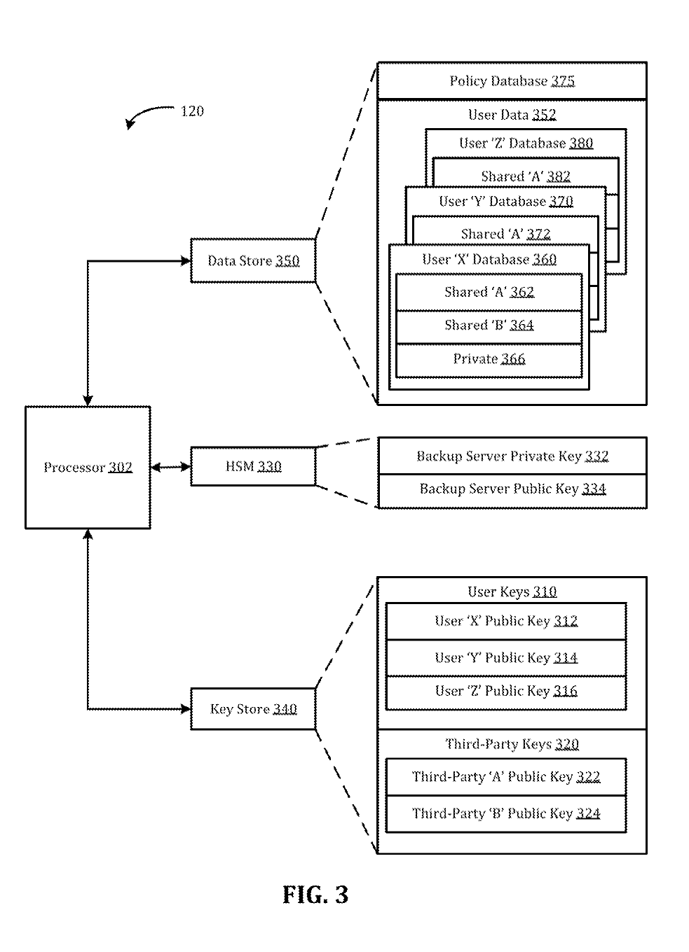

Reference is next made to FIG. 3 which illustrates in block diagram form an example backup server 120 suitable for storing data encrypted by storage device 200 and sending stored data to third-party devices in accordance with example embodiments. FIG. 3 only illustrates select components of backup server 120. Backup server 120 may receive data from one or more storage devices 200 for backup storage and for routing to other entities (e.g. to third-party device 130).

Backup server 120 includes a processor 302 which controls the overall operation of backup server 120. Processor 302 may interact with other components (not shown) including one or more input devices, RAM, ROM, persistent (non-volatile) memory, auxiliary I/O subsystems, one or more data port such as serial data port (e.g., USB data port), and other device subsystems. The components of the backup server 120 are coupled via a communications bus (not shown) which provides a communication path between the various components. As illustrated in FIG. 3, backup server 120 also includes data store 350, HSM 330, and key store 340, which may interact with processor 302.

HSM 330 may store backup server private and public keys 332, 334. Private and public keys 332, 334 are a mathematically linked key-pair associated exclusively with backup server 120. Backup server private key 332 may be used by the CA of backup server 120 to sign public keys associated with other devices in the system. Backup server public key 332 may thus be widely distributed to allow for other devices to decrypt signed keys.

Key store 340 may store user keys 310 (for example, User ‘X’ public key 312, User ‘Y’ public key 314, User ‘Z’ public key 316, and so forth). User keys are public keys associated with registered users, and may be received at backup server 120 from storage devices associated with various users during a registration process. The user keys may be used to uniquely identify different users and the storage devices associated with the users.

Key store 340 may also store third-party keys 320 (for example, third-party ‘A’ public key 322, third-party ‘B’ public key 324, and so forth). Third-party keys are public keys associated with registered third-party entities (e.g. a health-monitoring entity, or a home-monitoring entity). Third-parties may utilize data stored at storage devices and backup server 120 associated with users to provide services to users. Accordingly, users may wish to share their data with such third-party entities. However, there is no need for all third-party entities to receive all data associated with all users. For example, a home-monitoring entity may not need health data associated with the users. Accordingly, a system and method for storing backup data and selectively providing access to user data is advantageous.

Backup server 120 may receive data elements associated with one or more users from one or more storage devices 200. Backup server 120 includes data store 350, which may store a user data database 352. User data database may be implemented using a NoSQL database (such as CouchDB™, or PouchPC) using unstructured data.

Data elements received from each storage device 200 is associated with a user/storage device and may be stored in a separate database associated with the user/storage device. Each database may be associated with one of user keys 310 (i.e. User ‘X’ database 360 is associated with User ‘X’ public key 312, etc.). As shown in FIG. 3, user data 352 includes three databases, each storing data associated with a different user/storage device: User ‘X’ database 360, storing data associated with User ‘X’; User ‘Y’ database 370, storing data associated with User ‘Y’; and User ‘Z’ database 380, storing data associated with User ‘Z’. Each user data 352 database may include any number of databases to accommodate more or less users. In some embodiments, each storage device 200 is associated with a single user; thus, data received from a particular storage device is automatically stored in the corresponding user database. In other embodiments, each storage device 200 may be associated with more than one user, and data received from a multiuser storage device is stored in the corresponding user database based on a user ID sent by the multiuser storage device and received at backup server 120.

Each user database 360, 370, and 380 in user data 352 replicates the different partitions stored on the corresponding storage device. As shown in FIG. 3, User ‘X’ database 360 includes three partitions: Shared ‘A’ 362, Shared ‘B’ 364, and Private 366. The partitions may be mirror images of the partitions stored on the corresponding user storage device. Similarly, as shown in FIG. 3, User ‘Y’ database 370 includes partition Shared ‘A’ 372, and User ‘Z’ database 380 includes partition Shared ‘A’ 382. Each user database may include any number of partitions.

Upon receiving a data element (e.g. from storage device 200), backup server 120 may store the data element in the user database corresponding with the user of the storage device that sent the data element. Storage device 200 may also send public keys associated with entities authorized to access the data element, thereby allowing backup server 120 to store each data element in the partition or partitions associated with the authorized entity or entities. Backup server 120 may also assign each data element received at backup server 120 a unique ID to identify the data element. The unique ID may be appended to the file storing the data element or may be assigned to the data element in a database (not shown).

Backup server 120 may also generate a hash (e.g. using Secure Hash Algorithm (‘HSM’)) of all unique IDs stored in each partition. The hash of the unique IDs provides a representation of the state of data stored in each partition at the backup server. Backup server 120 may thus compare the state of data stored in each partition at the backup server with the state of data stored in another partition at another device by generating a hash of the unique IDs. If the hash is identical, then the two partitions store the same data elements. This allows backup server 120 to determine the state of each partition without decrypting the data elements. Backup server 120 may send the unique ID associated with each data element to storage device 200 and/or third-party devices 130, 132.

Data store 350 may also store a policy database 375. Policy database 375 may define entities that are authorized to access each of the one or more partitions in each user database. Backup server 120 may send data stored in user data database 352 to authorized entities.

Policy database 375 may use the public key associated with each user (as stored in user keys 310) as a unique key. For example, policy database 375 may store the data shown Table 1 to define authorized entities for partitions of User ‘X’ database 360. As shown in Table 1, policy database may include four data fields: UserID, uniquely identifying the user with the corresponding user public key; UserDatabase, identifying the user database stored in user data 352; UserPartition, identifying a particular partition in the identified user database; and AuthorizedEntity, identifying one or more entities by the public key associated with the third-party entity authorized to access data stored in the particular partition. As shown in Table 1, Third-Party ‘A’ is authorized to access data stored in partition Shared ‘A’ 362 in User ‘X’ Database 360; Third-Party ‘B’ is authorized to access data stored in partition Shared ‘B’ 364 in User ‘X’ Database 360; and User ‘X’ is authorized to access data stored in partition Private 366 in User ‘X’ Database 360.

TABLE 1

| [k] UserID | User ‘X’ Public Key | User ‘X’ Public Key | User ‘X’ Public Key |
|---|---|---|---|
| | 312 | 312 | 312 |
| UserDatabase | User ‘X’ Database | User ‘X’ Database | User ‘X’ Database |
| | 360 | 360 | 360 |
| UserPartition | Shared ‘A’ 362 | Shared ‘B’ 364 | Private 366 |
| AuthorizedEntity | Third-Party ‘A’ | Third-Party ‘B’ Public | User ‘X’ Public Key |
| | Public Key 322 | Key 324 | 312 |

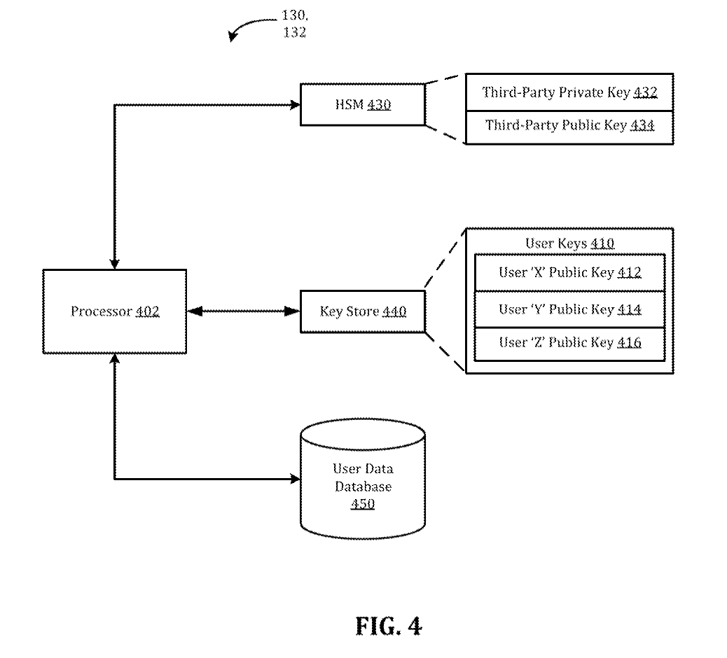

Reference is next made to FIG. 4 which illustrates in block diagram form an example third-party device 130, 132 (hereinafter referred to as third-party device 130) suitable for storing data encrypted by storage device 200 in accordance with example embodiments. FIG. 4 only illustrates select components of third-party device 130. Third-party device 130 may receive user data from storage device 200 or from backup device 120 in accordance with policy database 275 and/or 375. Third-party device 130 may be associated with an entity which may utilize user data to provide services to users.

Third-party device 130 includes a processor 402 which controls the overall operation of third-party device 130. Processor 402 may interact with other components (not shown) including one or more input devices, RAM, ROM, persistent (non-volatile) memory, auxiliary I/O subsystems, one or more data port such as serial data port (e.g., USB data port), and other device subsystems. The components of the third-party device 130 are coupled via a communications bus (not shown) which provides a communication path between the various components. As illustrated in FIG. 4, third-party device 130 also includes user data database 450, HSM 430, and key store 440, which may interact with processor 402.

HSM 430 may store third-party device private and public keys 432, 434. Private and public keys 432, 434 are a mathematically linked key-pair associated exclusively with third-party device 130. Third-party device public key 434 may be signed by the CA of backup server 120.

Key store 440 may store user keys 410 (for example, User ‘X’ public key 412, User ‘Y’ public key 414, User ‘Z’ public key 416, and so forth). User keys 410 are public keys associated with registered users, and may be received at third-party device 130 from storage devices associated with various users during a registration process. The user keys may be used to uniquely identify different users and the storage devices associated with the users.

User data database 450 may store data associated with users of one or more storage devices 200, include sensor data and other data. User data database 450 may be implemented using an SQL database to allow for easy retrieval of data. Third-party device 130 may receive the user data from either backup server 120 or from storage device 200. Each data element received may be associated with a particular user, as identified by the user's public key. Additionally, each data element received may be encrypted. Accordingly, third-party device 130 may decrypt the received data elements, then store plaintext data elements in user data database 450. Each data element in user data database 450 may be associated with the corresponding user's public key. Each data element may also be associated with its unique ID.

Reference is now made to FIGS. 5A-5D, which illustrate, in block-diagram form, example files 502, 504, 506, and 508, respectively. Each file stores an encrypted data element 510. Encrypted data element 510 may contain encrypted sensor data. Additionally, each file stores one or more encrypted symmetric keys to allow each entity that is authorized to access the data element, as defined in policy database 275, to decrypt the data element. Files 502, 504, 506, and 508 may be produced by storage device 200 and may be stored in data store 250 of storage device 200. Storage device 200 may also send the files to backup server 120, which may also store the files in data store 350 of backup server 120. Backup server 120 may append to each file a unique ID associated with the file (not shown).

As shown in FIG. 5A, file 502 stores encrypted symmetric key 512 in addition to encrypted data element 510. Encrypted symmetric key 512 is encrypted using storage device public key 512. Encrypted symmetric key 512 can be decrypted using storage device private key. As previously explained, storage device private key is stored in HSM 230 of storage device 200, and is not shared with any other entity. Accordingly, only storage device 200 is capable of decrypting encrypted symmetric key 512. Furthermore, for a computing device to decode encrypted data element 510, the computing device requires encrypted symmetric key 512. Since only storage device 200 is capable of decrypting encrypted symmetric key 512, only storage device 200 is capable of accessing encrypted data element 510 of file 502. File 502 may be stored in partition Private 266 in data store 250 of storage device 200. File 502 may also be stored in partition Private 366 in data store 350 of backup server 120.

As shown in FIG. 5B, file 504 stores encrypted symmetric key 512 and encrypted symmetric key 514 in addition to encrypted data element 510. Encrypted symmetric key 512 is encrypted using storage device public key 512, whereas, encrypted symmetric key 514 is encrypted using third-party ‘A’ public key (third-party ‘A’ public key is stored in key store 240 of storage device 200). Similarly to file 502, storage device 200 is capable of accessing encrypted data element 510 of file 504 by decrypting encrypted symmetric key 512. Additionally, third-party ‘A’ device 130 is also capable of accessing encrypted data element 510 of file 504 by decrypting encrypted symmetric key 514, since third-party ‘A’ device 130 stores in HSM 430 third-party ‘A’ private key. Accordingly, both storage device 200 and third-party ‘A’ device 130 are capable of accessing encrypted data element 510 of file 504. File 504 may be stored in partition Private 266 and in partition Shared ‘A’ 262 in data store 250 of storage device 200. File 504 may also be stored in partition Private 366 and in partition Shared ‘A’ 362 in data store 350 of backup server 120.

As shown in FIG. 5C, file 506 stores encrypted symmetric key 512, encrypted symmetric key 514, and encrypted symmetric key 516 in addition to encrypted data element 510. Encrypted symmetric key 516 is encrypted using third-party ‘B’ public key (third-party ‘B’ public key is stored in key store 240 of storage device 200). Similarly to file 504, both storage device 200 and third-party ‘A’ device 130 are capable of accessing encrypted data element 510 of file 506 by decrypting encrypted symmetric key 512, 514 respectively. Additionally, third-party ‘B’ device 132 is also capable of accessing encrypted data element 510 of file 506 by decrypting encrypted symmetric key 516, since third-party ‘B’ device 132 stores in HSM 430 third-party ‘B’ private key. Accordingly, storage device 200, third-party ‘A’ 130, and third-party ‘B’ device 132 are capable of accessing encrypted data element 510 of file 506. File 506 may be stored in partitions Private 266, Shared ‘A’ 262, and Shared ‘B’ 264 in data store 250 of storage device 200. File 506 may also be stored in partitions Private 366, Shared ‘A’ 362, and Shared ‘B’ 364 in data store 350 of backup server 120.

As shown in FIG. 5D, file 508 stores encrypted symmetric key 514 and encrypted symmetric key 516 in addition to encrypted data element 510. Accordingly, third-party ‘A’ 130 and third-party ‘B’ device 132 are capable of decrypting encrypted data element 510 of file 508. File 508 may be stored in partitions Shared ‘A’ 262 and Shared ‘B’ 264 in data store 250 of storage device 200. File 508 may also be stored in partitions Shared ‘A’ 362 and Shared ‘B’ 364 in data store 350 of backup server 120. Interestingly, while storage device 200 may create file 508, storage device 200 is not authorized to access file 508.

As shown in FIGS. 5A-5D, access to an encrypted data element may be permitted by including one or more symmetric keys encrypted using public key(s) associated with one or more authorized entities. Access to additional entities may be permitted at a later time—for example, file 502 may be created at an initial time, then file 504 may be created at a later by decrypting, by storage device 200, encrypted symmetric key 512, then encrypting the symmetric key twice, once using storage device public key 232 stored in HSM 230 and once using third-party ‘A’ public key 246 stored in key store 240. Similarly, access to a particular entity may be removed by deleting the corresponding encrypted symmetric key in the file.

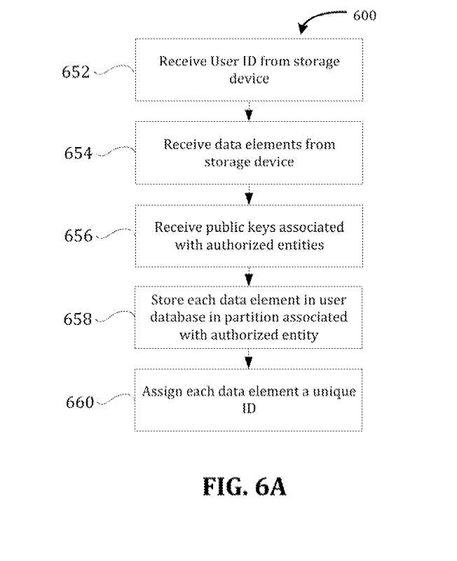

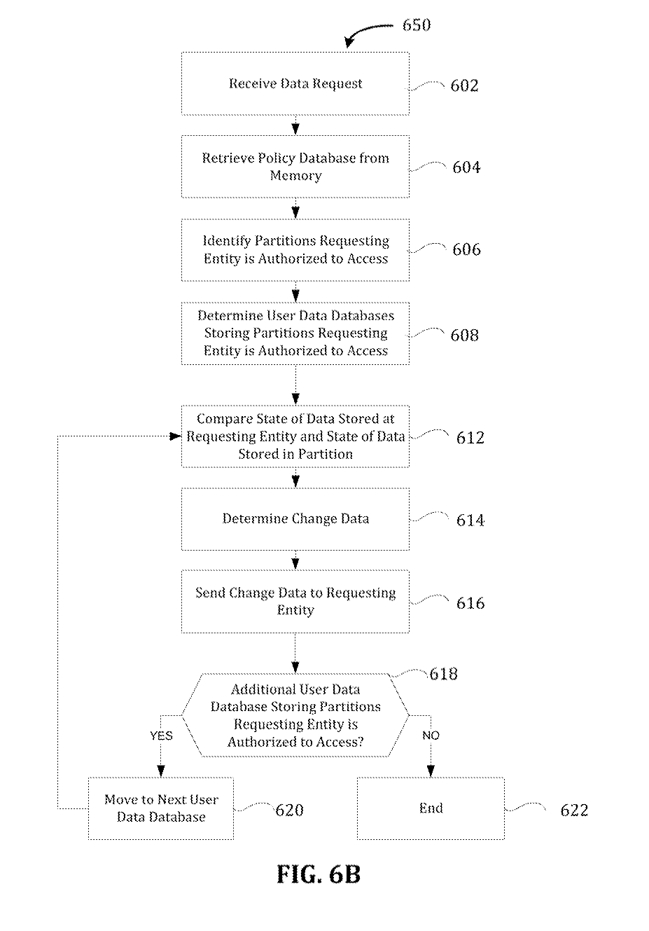

Reference is now made to FIGS. 6A-6B which illustrate flowcharts of example methods 600, 650 for storing data elements received at backup server 120 and for sending data elements to authorized entities (e.g. third-party devices 130, 132). Methods 600, 650 may be implemented by backup server 120. Method 600 may be carried out by software executed, for example, by a processor, or alternatively, by hardware components. Coding of software for carrying out such methods is within the scope of a person of ordinary skill in the art. Methods 600, 650 may contain additional or fewer processes than shown and/or described, and may be performed in a different order. Computer-readable code executable by the processor 302 of backup server 120 to perform methods 600, 650 may be stored in a computer-readable medium, such as memory of backup server 120.

FIG. 6A illustrates a flowchart of example method 600 for storing data elements received at backup server 120. At block 652, backup server 120 receives, via Internet 115, a user ID from a storage device 200 identifying the storage device. The user ID may be the storage device public key, as stored in HSM 230. The user ID is unique to each user. Backup server 120 may determine which user data database 352 is associated with the user ID (e.g. User ‘X’ database 360, User ‘Y’ database 370, or User ‘Z’ database 380). Backup server may store each data element received from the particular storage device 200 in the user data database 352 associated with the user ID.

Storage device 200 may send encrypted data elements in files (such as files 502-508) to backup server 120. Each file may also include a list of entities that are authorized to access the data element. Each entity may be identified by its public key. At block 654, backup server 120 receives, via Internet 115, encrypted data elements from the storage device and, at block 656, backup server 120 receives the public keys associated with entities authorized to access each data element. Backup server 120 may determine which partitions are associated with each authorized entity based on the received public keys and further based on data stored in policy database 375 (e.g. partitions Shared ‘A’ 362, Shared ‘B’ 364, and Private 366 in User ‘X’ database). Backup server 120 may store policy database 375 which maps relationships between each entity and the partitions, as previously discussed. At block 658, backup server 120 may store each data element in the partition in the user data database that is associated with entity or entities that are authorized to access the data element. Furthermore, if more than one entity is authorized to access the data element, backup server 120 may store the data element in more than one partition.

At block 660, backup server 120 may assign each data element a unique ID. The unique ID may be assigned using a counter, whereby each data element receives a number based on the order that the data element is stored in a user data database. Backup server 120 may append the unique ID of each data element to the file storing the data element.

FIG. 6B illustrates a flowchart of example method 650 for sending data elements stored at backup server 120 to authorized entities. As illustrated in FIG. 3, backup server 120 stores user data in one or more databases 352. Each database is associated with a user and has an associated user ID (e.g. the public key associated with the user). Each database may have one or more partitions, and each partition is associated with one or more entities (e.g. third-party devices 130, 132, or a storage device 200). Backup server 120 stores user data in the appropriate partition in accordance with method 600. Each partition may store files similar to files 502-508 of FIGS. 5A-5D. Each file may include a data element encrypted using a symmetric key, and the symmetric key encrypted using the public key associated with entities that are authorized to access the partition.

Entities such as third-party devices 130, 132 or a storage device 200 may send a data request to backup server 120 to retrieve data stored at backup server 120. For storage device 200, this may be helpful in restoring lost data to the storage device 200. Third-party devices 130, 132 may instead request data from backup server 120 as it acts as a centralized data store for data associated with all users registered with the third-party device (i.e. instead of requesting the data from each storage device separately). Accordingly, at block 602, backup server 120 may receive, from a requesting entity, a request to send data associated with the requesting entity. The requesting entity may identify itself by including a requestor public key associated with the requesting entity.

Upon receiving the data request, backup server 120 may, at block 604, retrieve policy database 375 from data store 350. As previously discussed, policy database 375 defines entities that are authorized to access each of the one or more partitions stored in user data database 352. The public key associated with each entity is stored in policy database 375; thus, backup server 120 may, at block 606, use the requestor public key to query policy database 375 to identify which partitions the requesting entity is authorized to access. If the requesting entity is not authorized to access any stored partition (i.e. policy database 375 does not store the requestor public key), backup server 120 may send an error message to the requesting entity and end method 650.

Similarly to backup server 120, the requesting entity may have several users registered with the entity. However, backup server 120 may have more registered users; i.e. not all users registered with backup server 120 must be registered with the requesting entity. Accordingly, at block 608, backup server 120 may determine which of user data databases 352 store partitions that the requesting entity is authorized to access. For example, if the requesting entity is only authorized to access partition Shared ‘D’, then User ‘X’ database 360 does not store any partitions that the requesting entity is authorized to access (as illustrated in FIG. 3). Similarly, if the requesting entity is only authorized to access partition Shared ‘A’, then the requesting entity is authorized to access partitions in User ‘X’ database 360, User ‘Y’ database 370, and User ‘Z’ database 380 (as illustrated in FIG. 3). To determine which of user data databases 352 store partitions that the requesting entity is authorized to access, backup server 120 may query policy database 375 using the requestor public key, or alternatively, backup server 120 may query each database to determine if the database stores the required partition(s).

For each database that stores partitions that the requesting entity is authorized to access, backup server 120 may send, to the requesting entity, the data stored in the partitions that the requesting entity is authorized to access. Backup server 120 may also send a user ID associated with each database to allow the requesting entity to associate the data from the database with a particular user. The requesting entity may store the data of multiple users in a single user data database 450, and may associate each entry in the database by the user ID.

However, the requesting entity may already store some or all the data stored in one or more partitions. To increase efficiency, backup server 120 may send only data that is not stored at the requesting entity; i.e. the change data. The requesting entity may facilitate this by sending to backup server 120 (e.g. in the data request) a hash representing a state of data stored at the requesting entity. The hash may be a hash of unique IDs associated with files stored at the requesting entity. Alternatively, the requesting entity may send the unique ID associated with the last file the requesting entity received from backup server 120. Accordingly, at block 612, backup server 120 may compare the state of data stored at the requesting entity with the state of data stored at the backup server 120—e.g. by computing a hash and comparing the hash, or by comparing the unique ID associated with the last file the requesting entity received from backup server 120 and the unique ID associated with the last file backup server 120 assigned. Backup server 120 may thus, at block 614, determine the change data; i.e. the difference between the data stored at the requesting entity and data stored at backup server 120. Backup server 120 may identify the files that are stored at backup server 120 but not at the requesting entity. At block 616, backup server 120 may send the change data to the requesting entity.

In some embodiments, the data request sent by the requesting entity includes a hash for each user database and/or partition that the requesting entity is authorized to access. Accordingly, backup server 120 may compute the change data for each database and/or partition that the requesting entity is authorized to access separately.

At block 618, backup server 120 determines whether it stores additional user data databases that store partitions that the requesting entity is authorized to access. As previously discussed, the number of user data databases that the requesting entity is authorized to access will depend on the number of users registered with the requesting entity. If backup server 120 does store additional databases that the requesting entity is authorized to access, then method 650 proceeds to block 620. At block 620, backup server 120 moves to the next user data database that the requesting entity is authorized to access. If backup server 120 does not store additional databases that the requesting entity is authorized to access, then method 650 proceeds to end at block 622. Accordingly, in accordance with example embodiments, backup server 120 may store encrypted data and may selectively share the encrypted data without examining the contents of the encrypted data.

The steps and/or operations in the flowcharts and drawings described herein are for purposes of example only. There may be many variations to these steps and/or operations without departing from the teachings of the present disclosure. For instance, the steps may be performed in a differing order, or steps may be added, deleted, or modified.

While the present disclosure is described, at least in part, in terms of methods, a person of ordinary skill in the art will understand that the present disclosure is also directed to the various components for performing at least some of the aspects and features of the described methods, be it by way of hardware components, software or any combination of the two, or in any other manner. Moreover, the present disclosure is also directed to a pre-recorded storage device or other similar computer readable medium including program instructions stored thereon for performing the methods described herein.

Variations may be made to some example embodiments, which may include combinations and sub-combinations of any of the above. The various embodiments presented above are merely examples and are in no way meant to limit the scope of this disclosure.

Variations of the innovations described herein will be apparent to persons of ordinary skill in the art, such variations being within the intended scope of the present disclosure. In particular, features from one or more of the above-described embodiments may be selected to create alternative embodiments comprised of a sub-combination of features which may not be explicitly described above. In addition, features from one or more of the above-described embodiments may be selected and combined to create alternative embodiments comprised of a combination of features which may not be explicitly described above. Features suitable for such combinations and sub-combinations would be readily apparent to persons skilled in the art upon review of the present disclosure as a whole. The subject matter described herein intends to cover and embrace all suitable changes in technology.

1. A method implemented by a computing device storing data in one or more databases, each database being associated with a user and having a user ID associated therewith, and each database having one or more partitions, each partition being associated with one or more entities, the method comprising:
receiving, from a requesting entity, a request to send data associated with the requesting entity, the request including a requestor public key associated with the requesting entity;
retrieving, from memory, a policy database, the policy database defining entities that are authorized to access each of the one or more partitions, each entity being uniquely identifiable by an entity public key associated with the entity;
identifying, based on the requestor public key and the policy database, partitions that the requesting entity is authorized to access;
determining which of the one or more databases store one or more partitions that the requesting entity is authorized to access; and
for each database that stores one or more partitions that the requesting entity is authorized to access, sending, to the requesting entity, the data stored in the one or more partitions that the requesting entity is authorized to access and a user ID associated with the database.

2. The method of claim 1, wherein each data element stored in each partition is encrypted using a symmetric key, and wherein the symmetric key is encrypted using the public key associated with the one or more entities that are authorized to access the partition.

3. The method of claim 2, wherein each data element stored in each partition has a unique ID associated therewith.

4. The method of claim 3, wherein the request includes a hash representing a state of data stored at the requesting entity, the method comprising:
comparing the state of data stored at the requesting entity with a state of data stored at the computing device; and
sending, to the requesting entity, change data, the change data representing the difference between data stored at the requesting entity and data stored at the computing device.

5. The method of claim 4, wherein the hash is a hash of the unique ID associated with each data element.

6. The method of claim 1, wherein each of the one or more databases is implemented using a NoSQL database.

7. The method of claim 1, wherein the computing device stores, in memory, public keys associated with entities registered with the computing device.

8. A computing-device storing data in one or more databases, each database being associated with a user and having a user ID associated therewith, and each database having one or more partitions, each partition being associated with one or more entities, comprising:
a processor; and
memory coupled to the processor and storing instructions for storing encrypted data elements, wherein the processor is configured to:
receive, from a requesting entity, a request to send data associated with the requesting entity, the request including a requestor public key associated with the requesting entity;
retrieve, from memory, a policy database, the policy database defining entities that are authorized to access each of the one or more partitions, each entity being uniquely identifiable by an entity public key associated with the entity;
identify, based on the requestor public key and the policy database, partitions that the requesting entity is authorized to access;
determine which of the one or more databases store one or more partitions that the requesting entity is authorized to access; and
for each database that stores one or more partitions that the requesting entity is authorized to access, send, to the requesting entity, the data stored in the one or more partitions that the requesting entity is authorized to access and a user ID associated with the database.

9. The computing device of claim 8, wherein each data element stored in each partition is encrypted using a symmetric key, and wherein the symmetric key is encrypted using the public key associated with the one or more entities that are authorized to access the partition.

10. The computing device of claim 9, wherein each data element stored in each partition has a unique ID associated therewith.

11. The computing device of claim 10, wherein the request includes a hash representing a state of data stored at the requesting entity, and wherein the processor is further configured to:
compare the state of data stored at the requesting entity with a state of data stored at the computing device; and
send, to the requesting entity, change data, the change data representing the difference between data stored at the requesting entity and data stored at the computing device.

12. The computing device of claim 11, wherein the hash is a hash of the unique ID associated with each data element.

13. The computing device of claim 8, wherein each of the one or more databases is implemented using a NoSQL database.

14. The computing device of claim 8, wherein the computing device stores, in memory, public keys associated with entities registered with the computing device.

15. A non-transient computer readable medium containing program instructions for causing a computing device storing data in one or more databases, each database being associated with a user and having a user ID associated therewith, and each database having one or more partitions, each partition being associated with one or more entities to perform the method of:
receiving, from a requesting entity, a request to send data associated with the requesting entity, the request including a requestor public key associated with the requesting entity;
retrieving, from memory, a policy database, the policy database defining entities that are authorized to access each of the one or more partitions, each entity being uniquely identifiable by an entity public key associated with the entity;
identifying, based on the requestor public key and the policy database, partitions that the requesting entity is authorized to access;
determining which of the one or more databases store one or more partitions that the requesting entity is authorized to access; and
for each database that stores one or more partitions that the requesting entity is authorized to access, sending, to the requesting entity, the data stored in the one or more partitions that the requesting entity is authorized to access and a user ID associated with the database.

16. The non-transient computer readable medium of claim 15, wherein each data element stored in each partition is encrypted using a symmetric key, and wherein the symmetric key is encrypted using the public key associated with the one or more entities that are authorized to access the partition.

17. The non-transient computer readable medium of claim 16, wherein each data element stored in each partition has a unique ID associated therewith.

18. The non-transient computer readable medium of claim 17, wherein the request includes a hash representing a state of data stored at the requesting entity, and wherein the instructions are further configured to cause the computing device to:
compare the state of data stored at the requesting entity with a state of data stored at the computing device; and
send, to the requesting entity, change data, the change data representing the difference between data stored at the requesting entity and data stored at the computing device.

19. The non-transient computer readable medium of claim 18, wherein the hash is a hash of the unique ID associated with each data element.

20. The non-transient computer readable medium of claim 15, wherein the computing device stores, in memory, public keys associated with entities registered with the computing device.
